(19) United States
(12) Patent Application Publication
(10) Pub. No.: US 2026/0251879 A1
(43) Pub. Date: Aug. 27, 2026

(54) LENS DEVICE AND IMAGING APPARATUS

(71) Applicant: FUJIFILM Corporation, Tokyo (JP)

(72) Inventors: Nobuyuki KONDO, Saitama-shi (JP); Satoru HORIKOSHI, Saitama-shi (JP)

(73) Assignee: FUJIFILM Corporation, Tokyo (JP)

(21) Appl. No.: 19/547,690

(22) Filed: Feb. 24, 2026

(30) Foreign Application Priority Data
Feb. 25, 2025 (JP) 2025-027843

(51) Int. Cl. G02B 7/02; G03B 17/12

(52) U.S. Cl. CPC G02B 7/023; G02B 7/026; G03B 17/12

(57) ABSTRACT

A lens device includes: a lens frame that holds a first lens; a holding frame that holds the lens frame and that includes an elongated hole; and an eccentric roller that is disposed in the elongated hole and that is fixed to the lens frame. In a view in a direction of a rotation axis of the eccentric roller, an outer periphery of the eccentric roller is divided into four regions by a first axis and a second axis intersecting at the rotation axis, and the outer periphery of the eccentric roller has, in the four regions, one tangent along the first axis in a first region, one tangent along the second axis in a second region, one tangent along the second axis in a third region, and one tangent along the first axis in a fourth region.

### CROSS-REFERENCE TO RELATED APPLICATIONS

This application is based on and claims priority under 35 USC 119 from Japanese Patent Application No. 2025-027843 filed on February 25, 2025, the contents of which are incorporated herein by reference.

### BACKGROUND OF THE INVENTION

### Field of the Invention

The present invention relates to a lens device and an imaging apparatus.

### Description of the Related Art

JP2016-029418A discloses a lens barrel including: a lens holding frame that holds an optical member; a fixing member; a first adjusting member that supports the lens holding frame in a position-adjustable manner; and a second adjusting member that supports the lens holding frame in a position-adjustable manner. The first adjusting member has a spherical portion. By rotating the first adjusting member around an adjustment axis that passes through a center point of the spherical portion and is perpendicular to an optical axis, the lens holding frame is movable in a straight direction of the adjustment axis. The second adjusting member allows the lens holding frame to be rotationally moved around a barrel rotation axis that passes through the center point of the spherical portion and is parallel to the optical axis. The lens barrel further includes a third adjusting member that supports the lens holding frame in a position-adjustable manner and a fourth adjusting member that supports the lens holding frame in a position-adjustable manner. The third adjusting member allows the lens holding frame to be rotationally moved around an axis that passes through the center point of the spherical portion and the fourth adjusting member, and the fourth adjusting member allows the lens holding frame to be rotationally moved around an axis passing through the center point of the spherical portion and the third adjusting member.

JP2010-008920A discloses a lens position adjustment structure including a lens holding frame that holds a lens, an outer frame having an optical axis direction position restricting surface that determines a position of the lens holding frame in an optical axis direction and that supports the lens holding frame to be movable in a plane perpendicular to the optical axis, an elastic holding member that is engaged with the outer frame and that elastically presses the lens holding frame toward the optical axis direction position restricting surface to hold the lens holding frame at a constant position with respect to the outer frame, and two elongated holes formed in the lens holding frame, the two elongated holes being disposed in the same plane orthogonal to the optical axis and having longitudinal directions that are substantially perpendicular to each other in the plane orthogonal to the optical axis. A movement force in a direction perpendicular to a longitudinal direction of each of the two elongated holes is applied by position adjustment means that are inserted into the two elongated holes to positionally adjust the lens holding frame held by the elastic holding member in the plane orthogonal to the optical axis.

JP2020-140086A discloses a stepped eccentric roller that is an eccentric roller including a through-hole, in which a plurality of usable regions and a plurality of unusable regions are provided on an outer periphery, a distance from a center of the through-hole is always constant within a range of each of the usable regions, and the distances from the center of the through-hole in the usable regions are different from each other.

### SUMMARY OF THE INVENTION

One embodiment according to the disclosed technology provides a lens device and an imaging apparatus that can facilitate lens adjustment.

(1)

A lens device comprising:

a lens frame that holds a first lens;

a holding frame that holds the lens frame and that includes an elongated hole; and

an eccentric roller that is disposed in the elongated hole and that is fixed to the lens frame,

in which, in a view in a direction of a rotation axis of the eccentric roller, an outer periphery of the eccentric roller is divided into four regions by a first axis and a second axis intersecting at the rotation axis, and

the outer periphery of the eccentric roller has, in the four regions,

one tangent along the first axis in a first region,

one tangent along the second axis in a second region,

one tangent along the second axis in a third region, and

one tangent along the first axis in a fourth region.

(2)

The lens device according to (1),

in which a relative positional relationship between the lens frame and the holding frame is changeable by rotation of the eccentric roller.

(3)

The lens device according to (2),

in which the relative positional relationship between the lens frame and the holding frame changes linearly with respect to a rotation amount of the eccentric roller.

(4)

The lens device according to (2),

in which a movement amount of the lens frame with respect to the holding frame is constant relative to a rotation amount of the eccentric roller.

(5)

The lens device according to any one of (1) to (4), further comprising:

a biasing member that biases the lens frame in a direction different from an extending direction of the elongated hole with respect to the holding frame.

(6)

The lens device according to any one of (1) to (5),

in which the elongated hole includes a first elongated hole that extends in a first direction and a second elongated hole that extends in a second direction different from the first direction, and

the eccentric roller is disposed in each of the first elongated hole and the second elongated hole.

(7)

The lens device according to (6),

in which the second direction is a direction perpendicular to the first direction.

(8)

The lens device according to (6),

in which the first direction is a direction along an optical axis of the first lens.

(9)

The lens device according to (6), further comprising:

a biasing member that biases the lens frame in a direction different from an extending direction of the elongated hole with respect to the holding frame,

in which the biasing member includes a first biasing member that biases the lens frame along a third direction different from the first direction and the second direction with respect to the holding frame.

(10)

The lens device according to (9),

in which the biasing member further includes a second biasing member that biases the lens frame along the first direction with respect to the holding frame.

(11)

The lens device according to any one of (6) to (10),

in which the first elongated hole and the second elongated hole are disposed circumferentially around an optical axis of the first lens.

(12)

The lens device according to any one of (1) to (11),

in which the eccentric roller includes a plurality of contact portions that come into contact with a plurality of jigs that rotate the eccentric roller.

(13)

The lens device according to (12),

in which the plurality of jigs have different tip shapes.

(14)

The lens device according to (12),

in which the plurality of jigs include a first jig and a second jig, and the contact portion includes

a first contact surface that is capable of being brought into contact with only the first jig among the first jig and the second jig in a direction along the rotation axis, and

a second contact surface that is capable of being brought into contact with only the second jig among the first jig and the second jig in the direction along the rotation axis.

(15)

The lens device according to (14),

in which the second contact surface is an upper surface of a wall portion that extends from the first contact surface, and

a side surface of the wall portion is capable of being brought into contact with the first jig and the second jig in a rotation direction.

(16)

The lens device according to (15),

in which a plurality of wall portions are disposed circumferentially around the rotation axis.

(17)

The lens device according to any one of (14) to (16),

in which the plurality of jigs include a third jig including two tip portions, and

the contact portion includes one or more pairs of hole portions into which the two tip portions are insertable at positions symmetric about the rotation axis.

(18)

An imaging apparatus comprising:

the lens device according to any one of (1) to (17).

According to the present invention, it is possible to provide a lens device and an imaging apparatus that can facilitate lens adjustment.

### BRIEF DESCRIPTION OF THE DRAWINGS

FIG. 1 is a perspective view showing an example of a lens device 100 according to the present embodiment.

FIG. 2 is a perspective view showing an example of lens frames 111 and 112 that hold a lens 101, a holding frame 120, and an eccentric roller 130.

FIG. 3 is a front view of the lens frames 111 and 112, the holding frame 120, and the eccentric roller 130 shown in FIG. 2.

FIG. 4 is a perspective view of the lens frames 111 and 112 shown in FIG. 2.

FIG. 5 is a perspective view of the holding frame 120 shown in FIG. 2.

FIG. 6 is a diagram showing an example of a shape of a first elongated hole 121.

FIG. 7 is a diagram showing an example of a shape of a second elongated hole 122.

FIG. 8 is a perspective view showing the eccentric roller 130 and a screw 140.

FIG. 9 is a top view showing a shape of an outer periphery of the eccentric roller 130.

FIG. 10 is a diagram showing an example of a relationship between a rotation angle of the eccentric roller 130 and an offset amount of the lens frame 112 with respect to the holding frame 120.

FIG. 11 is a cross-sectional view showing an example of a first biasing member that biases the lens frame 112 with respect to the holding frame 120.

FIG. 12 is a cross-sectional view showing an example of a second biasing member that biases the lens frame 112 with respect to the holding frame 120.

FIG. 13 is a perspective view of the eccentric roller 130 for describing an example of a contact portion of the eccentric roller 130.

FIG. 14 is a top view of the eccentric roller 130 shown in FIG. 13.

FIG. 15 is a perspective view showing an example of a first jig 160 that comes into contact with a first contact surface 133a of the eccentric roller 130.

FIG. 16 is a side view of the first jig 160 shown in FIG. 15.

FIG. 17 is a cross-sectional view showing a state in which the first jig 160 shown in FIG. 15 is in contact with the eccentric roller 130.

FIG. 18 is a perspective view showing an example of a second jig 170 that comes into contact with a second contact surface 133b of the eccentric roller 130.

FIG. 19 is a side view of the second jig 170 shown in FIG. 18.

FIG. 20 is a cross-sectional view showing a state in which the second jig 170 shown in FIG. 18 is in contact with the eccentric roller 130.

FIG. 21 is a diagram showing an example of a third jig 180 that comes into contact with a third contact surface 133c of the eccentric roller 130.

### DESCRIPTION OF THE PREFERRED EMBODIMENTS

Hereinafter, an example of an embodiment of the present invention will be described with reference to the drawings. In the present embodiment, the terms "upward direction", "downward direction", "leftward direction", "rightward direction", "forward direction", and "backward direction" are used, but these directions are relative directions set for convenience of description for the lens device shown in each drawing.

### Lens Device 100 According to Present Embodiment

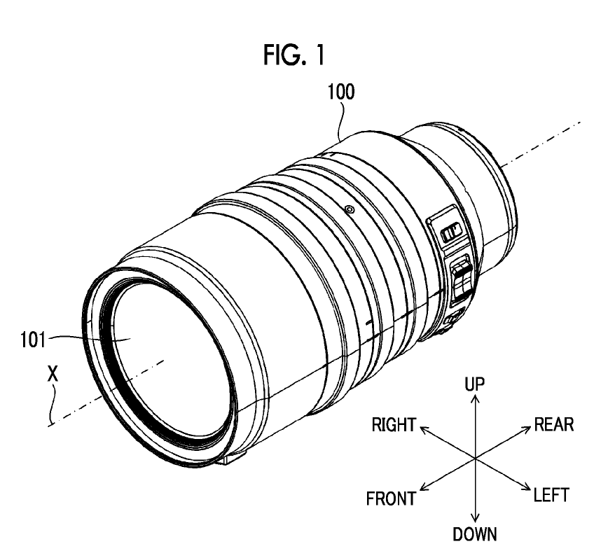

FIG. 1 is a perspective view showing an example of a lens device 100 according to the present embodiment. The lens device 100 is applied to, for example, a digital camera or a single-lens reflex camera capable of capturing video images. The camera is an example of an "imaging apparatus" according to the present invention. The lens device 100 is attachable to and detachable from, for example, a lens-interchangeable camera body. In addition, the lens device 100 may be a lens included in a lens-integrated camera. The lens device 100 is configured to have a substantially cylindrical shape as a whole.

The lens 101 is at least one optical lens provided in the lens device 100, and is an example of a "first lens" according to the present invention. In the drawings, the shape of the lens 101 is schematically shown. An optical axis X is an optical axis of an optical lens of the lens device 100 including the lens 101.

### Configuration for Holding Lens 101

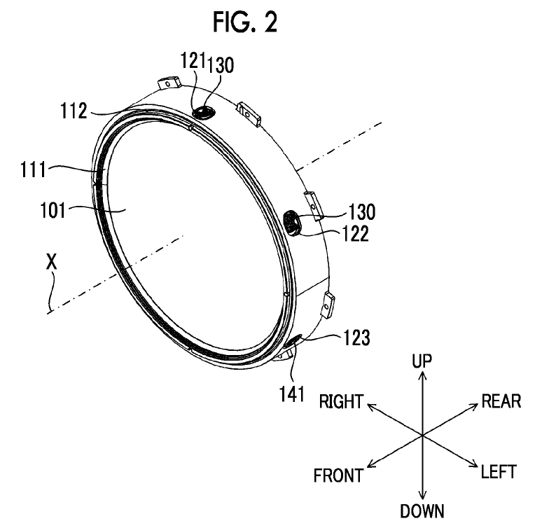

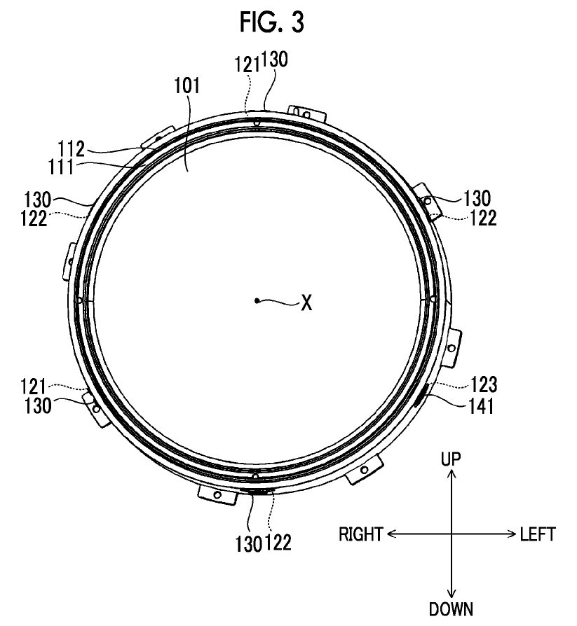

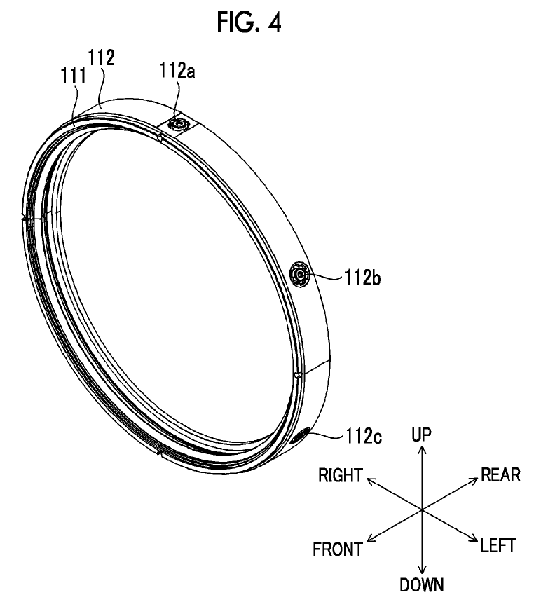

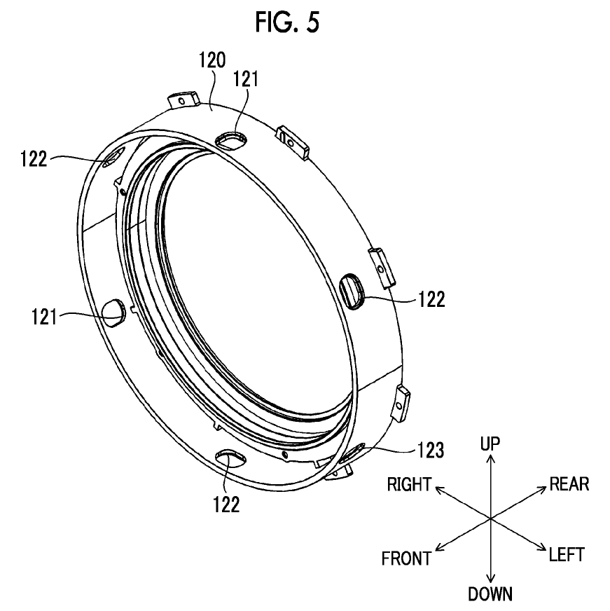

FIG. 2 is a perspective view showing an example of lens frames 111 and 112 that hold a lens 101, a holding frame 120, and an eccentric roller 130. FIG. 3 is a front view of the lens frames 111 and 112, the holding frame 120, and the eccentric roller 130 shown in FIG. 2. FIG. 4 is a perspective view of the lens frames 111 and 112 shown in FIG. 2. FIG. 5 is a perspective view of the holding frame 120 shown in FIG. 2.

The lens device 100 comprises, for example, the lens frames 111 and 112, the holding frame 120, and the eccentric roller 130 shown in FIG. 2. The lens frames 111 and 112 are substantially annular members that are fixed to each other and that hold the lens 101. Specifically, an outer peripheral portion of the lens 101 is fixed to an inner peripheral portion of the lens frames 111 and 112.

The lens frame 112 is provided with screw holes 112a, 112b, and 112c at positions corresponding to a first elongated hole 121, a second elongated hole 122, and a fulcrum hole 123 of the holding frame 120, which will be described below. The holding frame 120 is a substantially annular member that holds the lens frames 111 and 112. The holding frame 120 is fixed to a barrel of the lens device 100. Therefore, the holding frame 120 is fixed to the camera body.

A relative positional relationship between the lens frame 112 and the holding frame 120 is adjustable as will be described below. By adjusting the relative positional relationship between the lens frame 112 and the holding frame 120, a relative positional relationship between the lens 101 and the barrel or the camera body of the lens device 100 can be adjusted.

The holding frame 120 is provided with the first elongated hole 121, the second elongated hole 122, and the fulcrum hole 123. The first elongated hole 121, the second elongated hole 122, and the fulcrum hole 123 are holes that are provided along the optical axis X and that penetrate the holding frame 120 in a direction perpendicular (including substantially perpendicular) to the optical axis X. A penetrating direction of the first elongated hole 121, the second elongated hole 122, and the fulcrum hole 123 is not limited to the direction perpendicular to the optical axis X, and may be inclined with respect to the direction perpendicular to the optical axis X.

The first elongated hole 121 is a shift adjustment hole for adjusting a shift (in a direction perpendicular to the optical axis X) position of the lens frame 112 with respect to the holding frame 120. The second elongated hole 122 is a tilt adjustment hole for adjusting a tilt (inclination) of the lens frame 112 with respect to the holding frame 120. A plurality of first elongated holes 121 and second elongated holes 122 may be provided for the holding frame 120. In the examples of FIGS. 2 and 3, two first elongated holes 121 and three second elongated holes 122 are provided.

The fulcrum hole 123 is a hole that serves as a fulcrum for fixing the lens frame 112 to the holding frame 120. For example, by screwing a fixing screw 141 to the screw hole 112c (see FIG. 4) provided in the lens frame 112 via the fulcrum hole 123, the lens frame 112 can be fixed to the holding frame 120 at one point of the fulcrum hole 123. The shift position and the tilt are adjusted with the one point as the fulcrum.

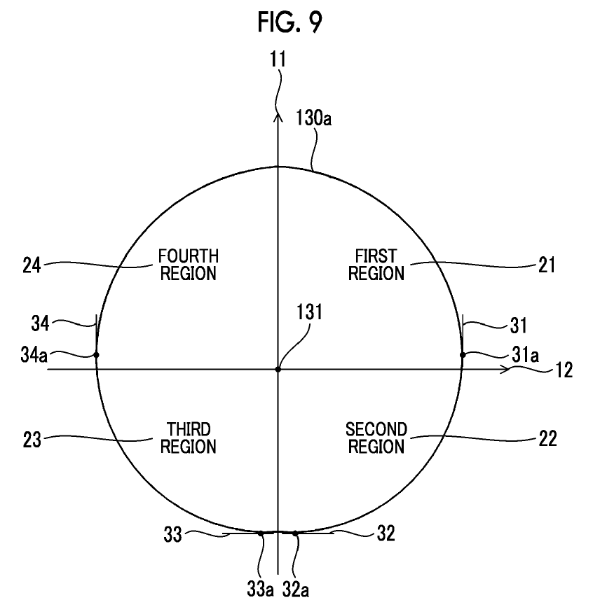

The eccentric roller 130 is a roller member having a center that is offset from the rotation axis (see FIG. 9). The eccentric roller 130 is disposed in each of the first elongated hole 121 and the second elongated hole 122 of the holding frame 120 and is rotatably fixed to the lens frame 112.

For example, by screwing the eccentric roller 130 disposed in the first elongated hole 121 to the screw hole 112a provided in the lens frame 112, the eccentric roller 130 is rotatably fixed to the lens frame 112. In addition, by screwing the eccentric roller 130 disposed in the second elongated hole 122 to the screw hole 112b provided in the lens frame 112, the eccentric roller 130 is rotatably fixed to the lens frame 112.

### Shape of First elongated hole 121

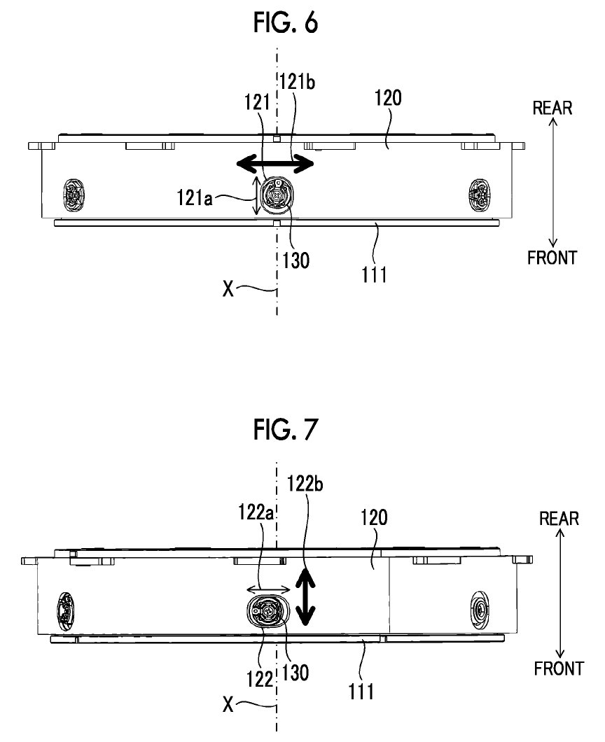

FIG. 6 is a diagram showing an example of a shape of a first elongated hole 121. The first elongated hole 121 is an elongated hole having a shape that extends in a first direction 121a along the optical axis X (a direction parallel to the optical axis X). For example, the first elongated hole 121 has a shape corresponding to a region through which a circle that moves in the first direction 121a passes.

Since the first elongated hole 121 has a shape that extends in the first direction 121a, in a case in which the eccentric roller 130 in the first elongated hole 121 is rotated, the lens frame 112 moves in a movement direction 121b perpendicular (including substantially perpendicular) to the first direction 121a with respect to the holding frame 120. As a result, the shift position of the lens frame 112 (lens 101) with respect to the holding frame 120 can be adjusted.

### Shape of Second elongated hole 122

FIG. 7 is a diagram showing an example of a shape of a second elongated hole 122. The second elongated hole 122 is an elongated hole having a shape that extends in a second direction 122a, which is a circumferential direction about the optical axis X. For example, the second elongated hole 122 has a shape corresponding to a region through which a circle that moves in the second direction 122a passes. The second direction 122a is a direction perpendicular (including substantially perpendicular) to the first direction 121a.

Since the second elongated hole 122 has a shape that extends in the second direction 122a, in a case in which the eccentric roller 130 in the second elongated hole 122 is rotated, the lens frame 112 moves in a movement direction 122b perpendicular (including substantially perpendicular) to the second direction 122a with respect to the holding frame 120. As a result, the tilt state of the lens frame 112 (lens 101) with respect to the holding frame 120 can be adjusted.

Eccentric Roller 130 and Screw 140

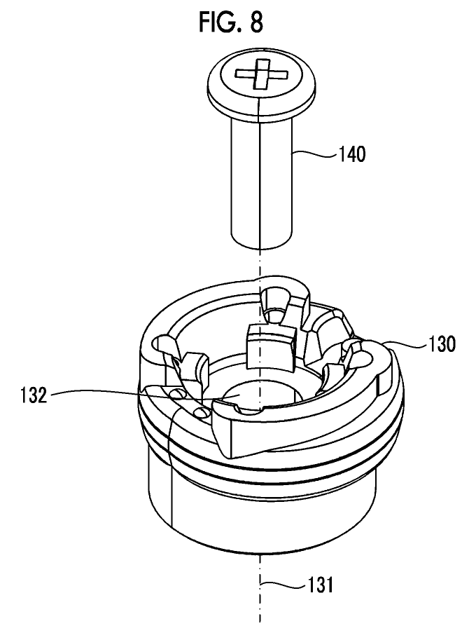

FIG. 8 is a perspective view showing the eccentric roller 130 and a screw 140. The eccentric roller 130 is made of, for example, a resin, but is not limited to a resin and may be made of a metal or the like. The eccentric roller 130 is fastened to the lens frame 112 by the screw 140 to be rotatably fixed to the lens frame 112. Specifically, the eccentric roller 130 has a through-hole 132 in the same direction as the penetrating direction of the first elongated hole 121 or the second elongated hole 122.

The through-hole 132 is a substantially cylindrical hole, and the screw 140 is insertable into the through-hole 132. At least a tip of the screw 140 is provided with a screw groove that can be screwed to the screw holes 112a and 112b of the lens frame 112.

The rotation axis 131 is a rotation axis of the eccentric roller 130 that is fastened by the screw 140. The eccentric roller 130 is rotatably fixed to the lens frame 112 about the rotation axis 131, but the rotation angle (rotation state) of the eccentric roller 130 with respect to the lens frame 112 is maintained by the biasing force generated by the fastening of the screw 140 unless a force for rotating the eccentric roller 130 is equal to or greater than a certain level. As a result, the shift position or the tilt state adjusted by the rotation of the eccentric roller 130 can be maintained.

The eccentric roller 130 may be fixed with an adhesive or the like so as to be unrotatable with respect to the lens frame 112 after the adjustment (the adjustment of the shift position or the tilt state) of the lens 101.

### Shape of Outer Periphery of Eccentric Roller 130

FIG. 9 is a top view showing a shape of an outer periphery of the eccentric roller 130. FIG. 9 shows an outer periphery 130a of the eccentric roller 130 as viewed in the direction of the rotation axis 131 of the eccentric roller 130. As shown in FIG. 9, the eccentric roller 130 is an eccentric roller member in which the outer periphery 130 a as viewed from the rotation shaft 131 is not a perfect circle with the rotation shaft 131 as the center. The shape of the eccentric roller 130 and the shapes of the first elongated hole 121 and the second elongated hole 122 can change the relative positional relationship between the lens frame 112 and the holding frame 120 in response to the rotation of the eccentric roller 130.

In addition, in FIG. 9, four regions divided by a first axis 11 and a second axis 12 intersecting at the rotation axis 131 are defined as a first region 21, a second region 22, a third region 23, and a fourth region 24 in a clockwise order. The outer periphery 130a has one tangent 31 parallel to the first axis 11 in the first region 21, one tangent 32 parallel to the second axis 12 in the second region 22, one tangent 33 parallel to the second axis 12 in the third region 23, and one tangent 34 parallel to the first axis 11 in the fourth region 24. That is, the outer periphery 130a of the eccentric roller 130 generally has a heart-like shape with rounded corners.

A contact point 31a is a contact point between the outer periphery 130a and the tangent 31. A contact point 32a is a contact point between the outer periphery 130a and the tangent 32. A contact point 33a is a contact point between the outer periphery 130a and the tangent 33. A contact point 34a is a contact point between the outer periphery 130a and the tangent 34. The contact point 32a and the contact point 33a are different points from each other.

### Relationship between Rotation Angle of Eccentric Roller 130 and Offset Amount of Lens Frame 112 with Respect to Holding Frame 120

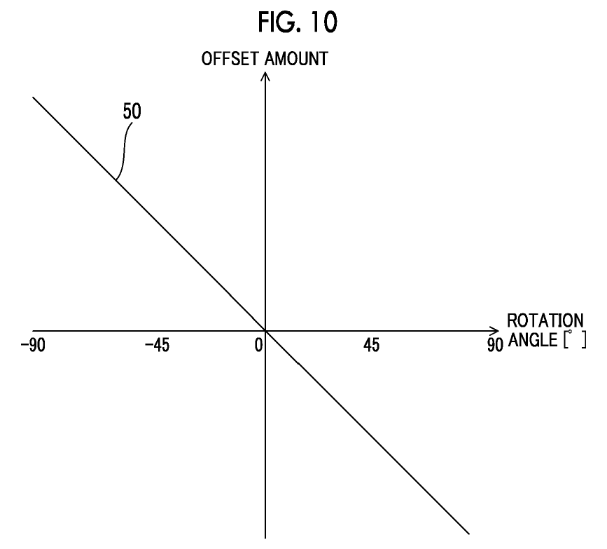

FIG. 10 is a diagram showing an example of a relationship between a rotation angle of the eccentric roller 130 and an offset amount of the lens frame 112 with respect to the holding frame 120. In FIG. 10, a horizontal axis indicates the rotation angle of the eccentric roller 130, and a vertical axis indicates the offset amount of the lens frame 112 with respect to the holding frame 120. The offset amount is a deviation of the relative position of the lens frame 112 with respect to the holding frame 120 from a predetermined reference position.

The offset amount of the lens frame 112 with respect to the holding frame 120 is an offset amount in a shift direction (movement direction 121b) for the eccentric roller 130 disposed in the first elongated hole 121 and is an offset amount in a tilt direction (movement direction 122b) for the eccentric roller 130 disposed in the second elongated hole 122. A relationship 50 shows a relationship between the rotation angle [°] of the eccentric roller 130 and the offset amount of the lens frame 112 with respect to the holding frame 120.

As shown in the relationship 50, the shape of the outer periphery 130a of the eccentric roller 130 shown in FIG. 9 can make a change (movement amount) in the offset amount of the lens frame 112 with respect to the holding frame 120 relative to a constant rotation amount of the eccentric roller 130 constant (including substantially constant) in a predetermined rotation angle range (in a range of -90 [°] to 90 [°] in the example of FIG. 10) of the eccentric roller 130. That is, the relative positional relationship between the lens frame 112 and the holding frame 120 can be changed linearly (including substantially linearly) with respect to the rotation amount of the eccentric roller 130.

As described above, the lens device 100 comprises the eccentric roller 130 that is disposed in the first elongated hole 121 and the second elongated hole 122 provided in the holding frame 120 holding the lens frames 111 and 112, and that is fixed to the lens frame 112. As a result, the shift position and the tilt state of the lens frame 112 with respect to the holding frame 120 can be adjusted by the rotation of the eccentric roller 130.

In addition, since the configuration (the first elongated hole 121 and the eccentric roller 130 disposed in the first elongated hole 121) for adjusting the shift position and the configuration (the second elongated hole 122 and the eccentric roller 130 disposed in the second elongated hole 122) for adjusting the tilt are independent of each other, the influence of each adjustment on the other can be suppressed, and the adjustment of the lens 101 can be facilitated.

Further, in a view in the direction of the rotation axis 131 of the eccentric roller 130, the outer periphery 130a of the eccentric roller 130 is divided into four regions by the first axis 11 and the second axis 12 intersecting at the rotation axis 131, and the outer periphery 130a has, in the four regions, one tangent 31 along the first axis 11 in the first region 21, one tangent 32 along the second axis 12 in the second region 22, one tangent 33 along the second axis 12 in the third region 23, and one tangent 34 along the first axis 11 in the fourth region 24.

As a result, the relative positional relationship between the lens frame 112 and the holding frame 120 can be changed linearly with respect to the rotation amount of the eccentric roller 130. As a result, in a case in which the rotation of the eccentric roller 130 is automatically performed by a robot, the control can be simplified as compared with a configuration in which the relative positional relationship between the lens frame 112 and the holding frame 120 changes nonlinearly, and in a case in which the rotation of the eccentric roller 130 is manually performed by a person, the adjustment work can be more intuitively performed. Therefore, the adjustment of the lens 101 can be facilitated.

First Biasing Member that Biases Lens Frame 112 with Respect to Holding Frame 120

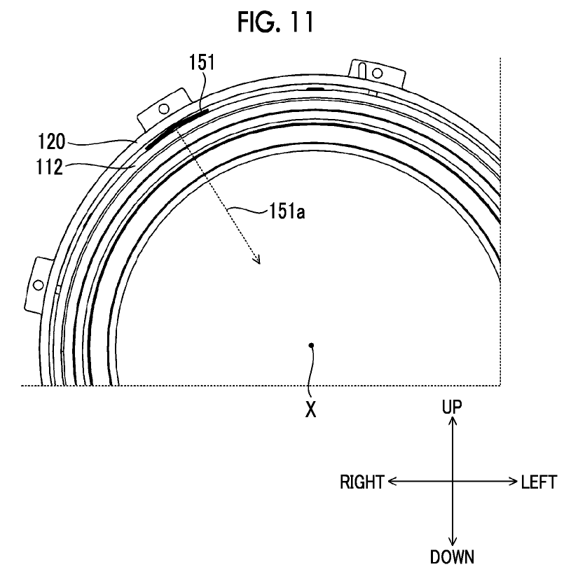

FIG. 11 is a cross-sectional view showing an example of a first biasing member that biases the lens frame 112 with respect to the holding frame 120. FIG. 11 shows a part of the lens frame 112 and the holding frame 120 as viewed from the direction of the optical axis X (from the front).

The lens device 100 may comprise a first biasing member 151. The first biasing member 151 is, for example, a spring such as a plate spring or a twisted coil spring. The first biasing member 151 is provided in a gap between the lens frame 112 and the holding frame 120 and biases the lens frame 112 in a third direction 151a (toward the optical axis X) with respect to the holding frame 120. The third direction 151a is a direction (a direction perpendicular to the optical axis X) perpendicular to the first direction 121a shown in FIG. 6 and the second direction 122a shown in FIG. 7.

By providing the first biasing member 151, a lost motion (clearance) between the lens frame 112 and the holding frame 120 in the third direction 151a can be suppressed. With this configuration, for example, even in a case in which the lost motion (clearance) between the eccentric roller 130 and the first elongated hole 121 exists due to the reason that the eccentric roller 130 provided in the first elongated hole 121 is made of a metal and hardly undergoes elastic deformation, a situation in which the shift position after the adjustment deviates can be suppressed.

Second Biasing Member that Biases Lens Frame 112 with Respect to Holding Frame 120

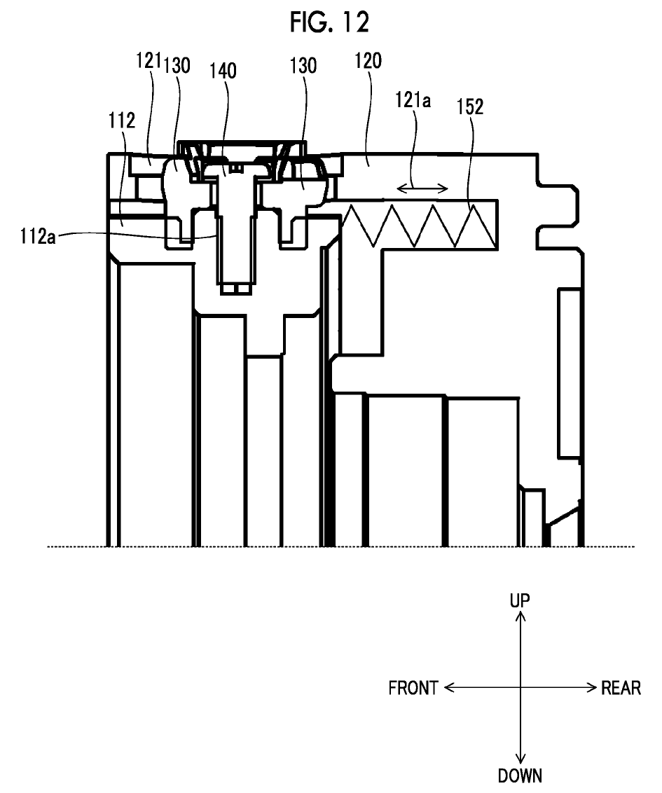

FIG. 12 is a cross-sectional view showing an example of a second biasing member that biases the lens frame 112 with respect to the holding frame 120. FIG. 12 shows a part (upper part) of a cross section obtained by cutting the lens frame 112, the holding frame 120, the eccentric roller 130, and the screw 140 with a plane passing through the optical axis X and parallel to the vertical direction.

The lens device 100 may comprise a second biasing member 152. The second biasing member 152 is, for example, a spring such as a plate spring or a twisted coil spring. The second biasing member 152 is provided in a gap between the lens frame 112 and the holding frame 120 and biases the lens frame 112 in the first direction 121a (in the forward direction) with respect to the holding frame 120. As described in FIG. 6, the first direction 121a is a direction along the optical axis X (a direction parallel to the optical axis X).

By providing the second biasing member 152, a lost motion (clearance) between the lens frame 112 and the holding frame 120 in the first direction 121a can be suppressed. With this configuration, for example, even in a case in which the lost motion (clearance) between the eccentric roller 130 and the second elongated hole 122 exists due to the reason that the eccentric roller 130 provided in the second elongated hole 122 is made of a metal and hardly undergoes elastic deformation, a situation in which the tilt state after the adjustment deviates can be suppressed.

As described above, the lens device 100 may comprise a biasing member that biases the lens frame 112 in a direction perpendicular to the extending direction of the elongated hole (the first elongated hole 121 or the second elongated hole 122) with respect to the holding frame 120. For example, the lens device 100 comprises the first biasing member 151 that biases the lens frame 112 with respect to the holding frame 120 in the third direction 151a. In addition, the lens device 100 comprises the second biasing member 152 that biases the lens frame 112 with respect to the holding frame 120 in the first direction 121a.

As a result, even in a case in which the eccentric roller 130 is made of a metal and hardly undergoes elastic deformation, a situation in which the shift position or the tilt state after the adjustment deviates can be suppressed. A configuration may be adopted in which a plurality of first biasing members 151 are provided at different positions. In addition, a configuration may be adopted in which a plurality of second biasing members 152 are provided at different positions. In addition, a configuration may be adopted in which only any one of the first biasing member 151 or the second biasing member 152 is provided.

### Contact Portion of Eccentric Roller 130

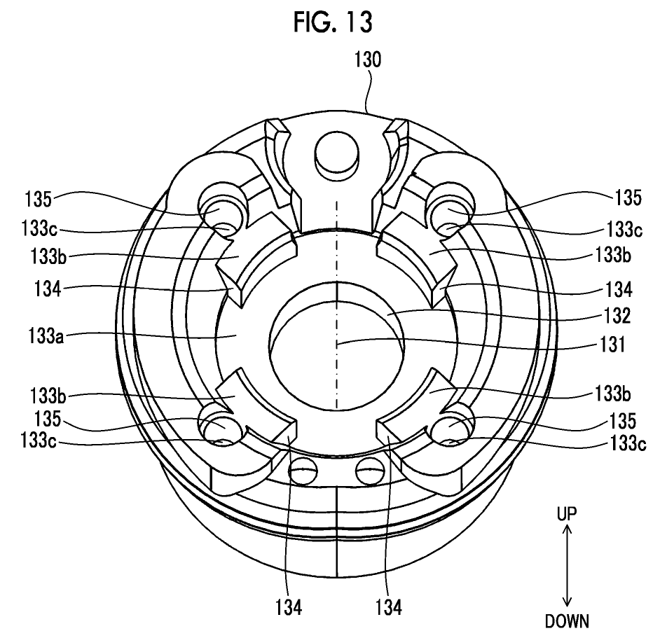

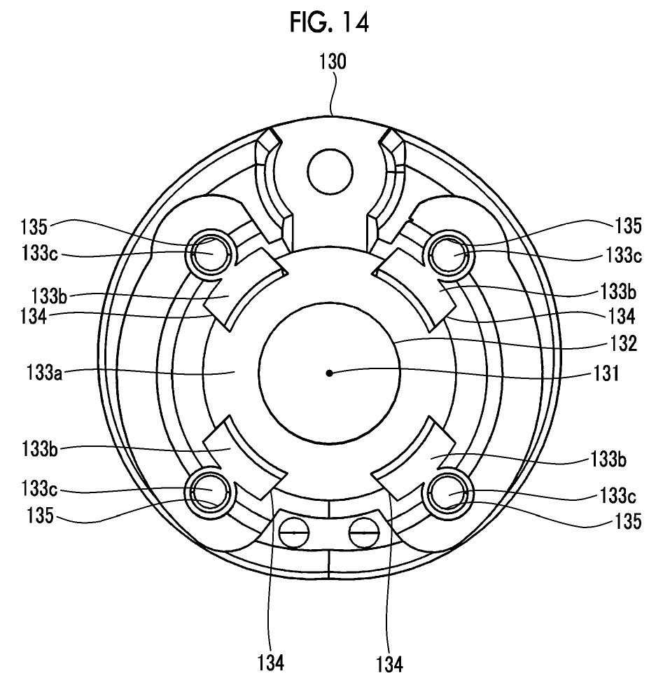

FIG. 13 is a perspective view of the eccentric roller 130 for describing an example of a contact portion of the eccentric roller 130. FIG. 14 is a top view of the eccentric roller 130 shown in FIG. 13. In the eccentric roller 130, a direction opposite to the lens frame 112 and the optical axis X is defined as an upward direction (upper side). As shown in FIGS. 13 and 14, the upper surface of the eccentric roller 130 is provided with a first contact surface 133a, a second contact surface 133b, and a third contact surface 133c.

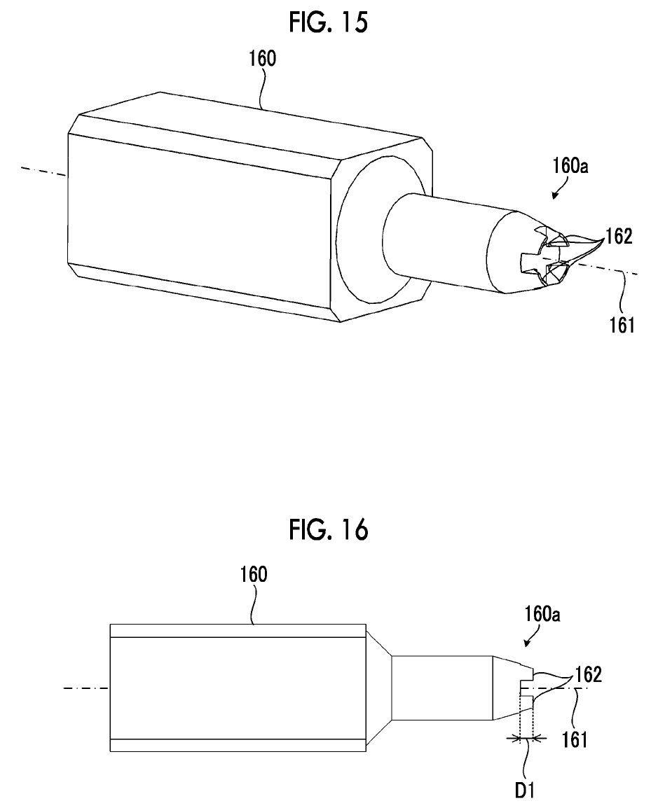

The first contact surface 133a, the second contact surface 133b, and the third contact surface 133c are contact portions that come into contact with jigs different from each other. The jigs different from each other are jigs having different shapes of tip portions that come into contact with the eccentric roller 130 (for example, see FIGS. 15 to 21).

The first contact surface 133a is a substantially planar shape having a substantially annular shape perpendicular to the rotation axis 131. The first contact surface 133a comes into contact with a first jig 160 (see FIGS. 15 to 17) described below.

The eccentric roller 130 is provided with four wall portions 134 that extend from an outer peripheral portion of the first contact surface 133a to the upper side. The four wall portions 134 are disposed at equal intervals on a circumference about the rotation axis 131.

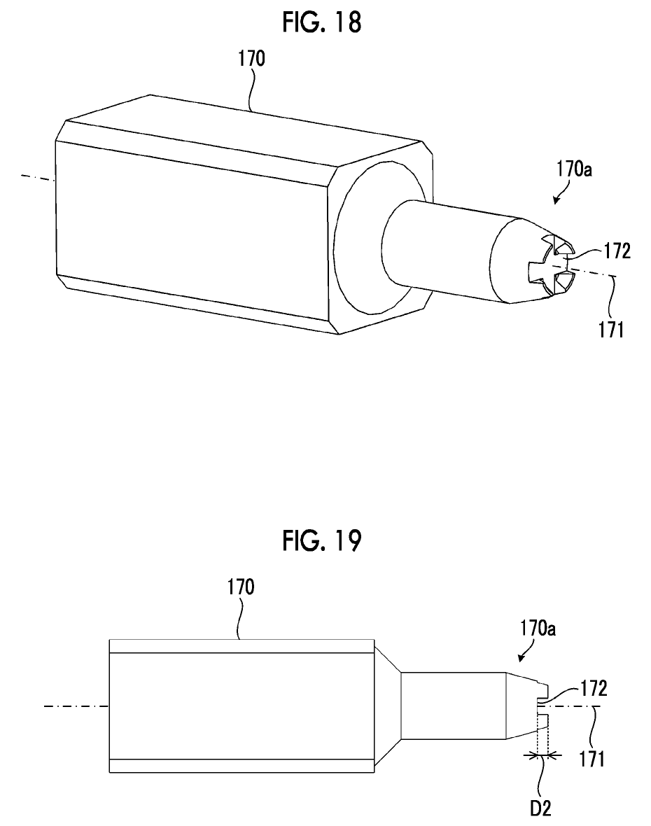

The second contact surface 133b is four substantially planar shapes positioned above the first contact surface 133a. The second contact surface 133b comes into contact with a second jig 170 (see FIGS. 18 to 20) described below. In this example, the second contact surface 133b is an upper surface of the four wall portions 134. Therefore, the four second contact surfaces 133b are disposed at equal intervals on a circumference about the rotation axis 131. Four hole portions 135 (holes having a bottom surface) are provided on an outer peripheral side of the four second contact surfaces 133b. The four hole portions 135 are substantially cylindrical holes in this example.

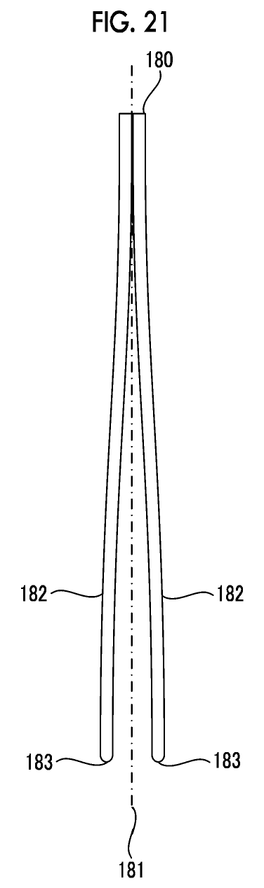

The third contact surface 133c is four substantially planar shapes positioned on an outer peripheral side of the four second contact surfaces 133b. The third contact surface 133c comes into contact with a third jig 180 (see FIG. 21) described below. In this example, the third contact surface 133c is a bottom surface of the four hole portions 135. Therefore, the four third contact surfaces 133c are disposed at equal intervals on a circumference about the rotation axis 131.

First Jig 160 that Comes into Contact with First Contact Surface 133a of Eccentric Roller 130

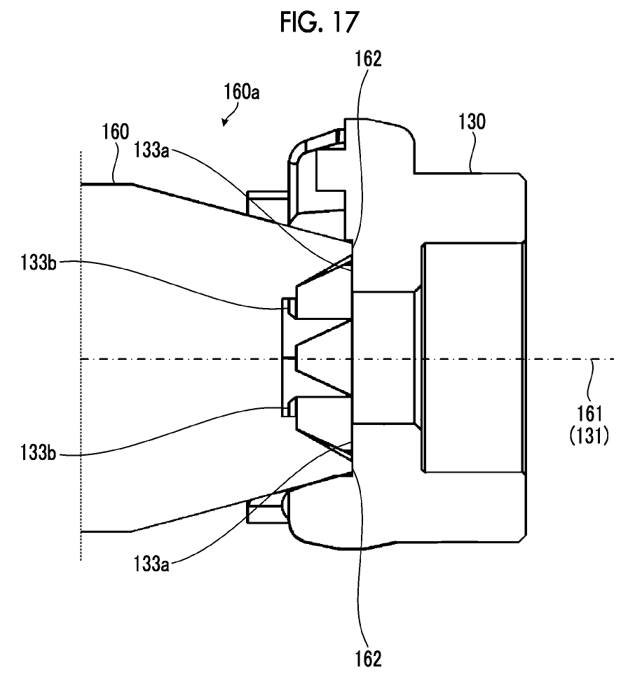

FIG. 15 is a perspective view showing an example of the first jig 160 that comes into contact with the first contact surface 133a of the eccentric roller 130. FIG. 16 is a side view of the first jig 160 shown in FIG. 15. FIG. 17 is a cross-sectional view showing a state in which the first jig 160 shown in FIG. 15 is in contact with the eccentric roller 130. FIG. 17 shows a part of a cross section obtained by cutting the first jig 160 and the eccentric roller 130 that are in contact with each other with a plane including the rotation axis 131.

The first jig 160 shown in FIGS. 15 and 16 is, for example, a bit that is used by being attached to an adjustment robot or a bit driver. A tip portion 160a of the first jig 160 is a portion that comes into contact with the eccentric roller 130. The tip portion 160a has a shape in which a substantially cross-shaped groove is provided in a substantially truncated conical shape that is thinner toward the tip.

A rotation axis 161 of the first jig 160 is a central axis of the first jig 160, and the first jig 160 has a substantially point-symmetrical shape about the rotation axis 161. The first jig160 is configured such that the tip portion 160a comes into contact with the eccentric roller 130 by being inserted into the eccentric roller 130 in a state in which the rotation axis 131 of the eccentric roller 130 and the rotation axis 161 of the first jig 160 coincide with each other.

Four surfaces at the foremost end of the tip portion 160a are contact surfaces 162 that come into contact with the first contact surface 133a of the eccentric roller 130 in the direction of the rotation axis 161 (rotation axis 131). The contact surface 162 is a substantially planar shape perpendicular to the rotation axis 161, and comes into contact with the first contact surface 133a by inserting the tip portion 160a of the first jig 160 into the eccentric roller 130.

In addition, four protrusion portions (including the contact surface 162) formed by the substantially cross-shaped groove in the tip portion 160a enter each of the four wall portions 134 of the eccentric roller 130. The four protrusion portions of the tip portion 160a are chamfered to be lower as the rotation axis 161 is approached. In addition, the four protrusion portions of the tip portion 160a come into contact (in the rotation direction) with side surfaces of the four wall portions 134 of the eccentric roller 130 in a circumferential direction about the rotation axis 161 (rotation axis 131). As a result, the eccentric roller 130 can be rotated about the rotation axis 131 by rotating the first jig 160 about the rotation axis 161 in a state in which the four contact surfaces 162 of the tip portion 160a are in contact with the first contact surface 133a of the eccentric roller 130.

In addition, a depth D1 (length in the direction of the rotation axis 161) of the substantially cross-shaped groove of the tip portion 160a is longer than a height (length in the direction of the rotation axis 131) of the wall portion 134 of the eccentric roller 130. Therefore, the tip portion 160a of the first jig 160 does not come into contact with the second contact surface 133b of the eccentric roller 130.

Second Jig 170 that Comes into Contact with Second Contact Surface 133b of Eccentric Roller 130

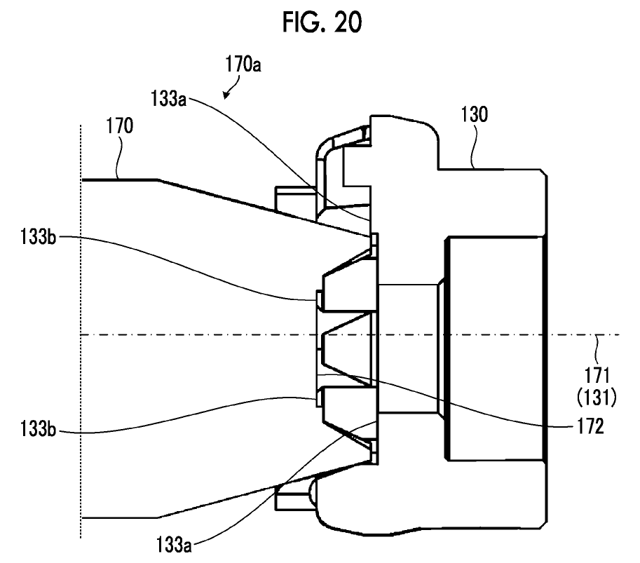

FIG. 18 is a perspective view showing an example of the second jig 170 that comes into contact with the second contact surface 133b of the eccentric roller 130. FIG. 19 is a side view of the second jig 170 shown in FIG. 18. FIG. 20 is a cross-sectional view showing a state in which the second jig 170 shown in FIG. 18 is in contact with the eccentric roller 130. FIG. 20 shows a part of a cross section obtained by cutting the second jig 170 and the eccentric roller 130 that are in contact with each other with a plane including the rotation axis 131.

The second jig 170 shown in FIGS. 18 to 20 is, for example, a bit that is used by being attached to an adjustment robot or a bit driver, as in the first jig 160. A tip portion 170a of the second jig 170 is a portion that comes into contact with the eccentric roller 130. The tip portion 170a has a shape in which a substantially cross-shaped groove is provided in a substantially truncated conical shape that is thinner toward the tip.

A rotation axis 171 of the second jig 170 is a central axis of the second jig 170, and the second jig 170 has a substantially point-symmetrical shape about the rotation axis 171. The second jig 170 is configured such that the tip portion 170a comes into contact with the eccentric roller 130 by being inserted into the eccentric roller 130 in a state in which the rotation axis 131 of the eccentric roller 130 and the rotation axis 171 of the second jig 170 coincide with each other.

A bottom surface of the substantially cross-shaped groove provided in the tip portion 170a is a contact surface 172 that comes into contact with the second contact surface 133b of the eccentric roller 130 in the direction of the rotation axis 171 (rotation axis 131). The contact surface 172 is a substantially planar shape perpendicular to the rotation axis 171 (rotation axis 131), and comes into contact with the second contact surface 133b by inserting the tip portion 170a of the second jig 170 into the eccentric roller 130.

In addition, four protrusion portions formed by the substantially cross-shaped groove in the tip portion 170a enter each of the four wall portions 134 of the eccentric roller 130. The four protrusion portions are chamfered to be lower as the rotation axis 171 is approached. In addition, the four protrusion portions of the tip portion 170a come into contact (in the rotation direction) with side surfaces of the four wall portions 134 of the eccentric roller 130 in a circumferential direction about the rotation axis 171 (rotation axis 131). As a result, the eccentric roller 130 can be rotated about the rotation axis 131 by rotating the second jig 170 about the rotation axis 171 in a state in which the contact surface 172 of the tip portion 170a is in contact with the second contact surface 133b of the eccentric roller 130.

In addition, a depth D2 (length in the direction of the rotation axis 171) of the substantially cross-shaped groove of the tip portion 170a is shorter than a height (length in the direction of the rotation axis 131) of the wall portion 134 of the eccentric roller 130. Therefore, the tip portion 170a of the second jig 170 does not come into contact with the first contact surface 133a of the eccentric roller 130.

As described above, the eccentric roller 130 includes the first contact surface 133a that is capable of being brought into contact with only the first jig 160 among the first jig 160 and the second jig 170 in the direction along the rotation axis 131, and the second contact surface 133b that is capable of being brought into contact with only the second jig 170 among the first jig 160 and the second jig 170 in the direction along the rotation axis 131.

As described above, the eccentric roller 130 includes a plurality of contact portions (the first contact surface 133a, the second contact surface 133b, and the third contact surface 133c) that come into contact with a plurality of jigs (the first jig 160, the second jig 170, and the third jig 180) that rotate the eccentric roller 130.

Third Jig 180 that Comes into Contact with Third Contact Surface 133c of Eccentric Roller 130

FIG. 21 is a diagram showing an example of a third jig 180 that comes into contact with a third contact surface 133c of the eccentric roller 130.

The third jig 180 is, for example, an adjustment tool that is gripped and used by a human hand. The third jig 180 has a forceps shape having two elongated arms 182 extending from a base end portion. Such an adjustment tool may be called a "crab claw".

A rotation axis 181 of the third jig 180 is a central axis of the third jig 180, and the third jig 180 has a substantially point-symmetrical shape about the rotation axis 181. The third jig180 is configured such that the rotation axis 131 of the eccentric roller 130 and the rotation axis 181 of the third jig 180 coincide with each other in a state in which the third jig 180 is in contact with the eccentric roller 130.

Tip ends of the two arms 182 are two tip portions 183 that come into contact with the third contact surface 133c of the eccentric roller 130 in the direction of the rotation axis 181 (rotation axis 131). For example, in a case in which the third jig 180 is inserted into two hole portions 135 at positions symmetric about the rotation axis 131 among the four hole portions 135 of the eccentric roller 130 such that the two arms 182 are respectively inserted into the two hole portions 135, the two tip portions 183 come into contact with two third contact surfaces 133c of the eccentric roller 130.

In addition, since the two arms 182 enter the two hole portions 135, the two arms 182 come into contact (in the rotation direction) with inner walls of the two hole portions 135 in a circumferential direction about the rotation axis 181 (rotation axis 131). As a result, the eccentric roller 130 can be rotated about the rotation axis 131 by rotating the third jig 180 about the rotation axis 181 in a state in which the tip portion 183 is in contact with the third contact surface 133c of the eccentric roller 130.

As described above, the eccentric roller 130 includes two pairs of the hole portions 135 (third contact surfaces 133c) that are disposed at positions symmetric about the rotation axis 131 and into which the two tip portions 183 of the third jig 180 can be inserted. The hole portions 135 (third contact surfaces 133c) are not limited to two pairs, and may be one pair or three or more pairs.

As described in FIGS. 13 to 21, the eccentric roller 130 includes a plurality of contact portions that come into contact with a plurality of jigs that rotate the eccentric roller 130. Although a configuration is described in which the eccentric roller 130 includes the first contact surface 133a, the second contact surface 133b, and the third contact surface 133c as the "plurality of contact portions", the eccentric roller 130 may have two types of the contact surfaces among these. With such a configuration, the lens 101 can be adjusted by using a jig according to an adjustment status of the lens device 100, such as equipment of a facility that adjusts the lens device 100 and skill level of an operator who adjusts the lens device 100. Therefore, the adjustment of the lens can be performed more flexibly.

### Modification Example

Although the adjustment of the shift position of the lens frame 112 with respect to the holding frame 120 and the adjustment of the tilt state of the lens frame 112 with respect to the holding frame 120 are described as the adjustment of the relative positional relationship between the holding frame 120 and the lens frame 112, only one of the adjustment of the shift position or the adjustment of the tilt state may be performed.

In addition, although a configuration is described in which the first elongated hole 121 and the second elongated hole 122 are provided in the holding frame 120 and the eccentric roller 130 is fixed to the lens frames 111 and 112, the present invention is not limited to such a configuration. For example, a configuration may be adopted in which the first elongated hole 121 and the second elongated hole 122 are provided in the lens frames 111 and 112 (for example, the lens frame 112) and the eccentric roller 130 is fixed to the holding frame 120. In this case, for example, a configuration is adopted in which the same screw holes as the screw holes 112ato 112c shown in FIG. 4 are provided in the holding frame 120.

### Explanation of References

11: first axis

12: second axis

21: first region

22: second region

23: third region

24: fourth region

31 to 34: tangent

31a, 32a, 33a, 34a: contact point

50: relationship

100: lens device

101: lens

111, 112: lens frame

112a to 112c: screw hole

120: holding frame

121: first elongated hole

121a: first direction

121b, 122b: movement direction

122: second elongated hole

122a: second direction

123: fulcrum hole

130: eccentric roller

130a: outer periphery

131, 161, 171, 181: rotation axis

132: through-hole

133a: first contact surface

133b: second contact surface

133c: third contact surface

134: wall portion

135: hole portion

140: screw

141: fixing screw

151: first biasing member

151a: third direction

152: second biasing member

160: first jig

160a, 170a, 183: tip portion

162, 172: contact surface

170: second jig

180: third jig

182: arm

What is claimed is:

1. A lens device comprising:
a lens frame that holds a first lens;
a holding frame that holds the lens frame and that includes an elongated hole; and
an eccentric roller that is disposed in the elongated hole and that is fixed to the lens frame,
wherein, in a view in a direction of a rotation axis of the eccentric roller, an outer periphery of the eccentric roller is divided into four regions by a first axis and a second axis intersecting at the rotation axis, and
the outer periphery of the eccentric roller has, in the four regions,
one tangent along the first axis in a first region,
one tangent along the second axis in a second region,
one tangent along the second axis in a third region, and
one tangent along the first axis in a fourth region.

2. The lens device according to claim 1,
wherein a relative positional relationship between the lens frame and the holding frame is changeable by rotation of the eccentric roller.

3. The lens device according to claim 2,
wherein the relative positional relationship between the lens frame and the holding frame changes linearly with respect to a rotation amount of the eccentric roller.

4. The lens device according to claim 2,
wherein a movement amount of the lens frame with respect to the holding frame is constant relative to a rotation amount of the eccentric roller.

5. The lens device according to claim 1, further comprising:
a biasing member that biases the lens frame in a direction different from an extending direction of the elongated hole with respect to the holding frame.

6. The lens device according to claim 1,
wherein the elongated hole includes a first elongated hole that extends in a first direction and a second elongated hole that extends in a second direction different from the first direction, and
the eccentric roller is disposed in each of the first elongated hole and the second elongated hole.

7. The lens device according to claim 6,
wherein the second direction is a direction perpendicular to the first direction.

8. The lens device according to claim 6,
wherein the first direction is a direction along an optical axis of the first lens.

9. The lens device according to claim 6, further comprising:
a biasing member that biases the lens frame in a direction different from an extending direction of the elongated hole with respect to the holding frame,
wherein the biasing member includes a first biasing member that biases the lens frame along a third direction different from the first direction and the second direction with respect to the holding frame.

10. The lens device according to claim 9,
wherein the biasing member further includes a second biasing member that biases the lens frame along the first direction with respect to the holding frame.

11. The lens device according to claim 6,
wherein the first elongated hole and the second elongated hole are disposed circumferentially around an optical axis of the first lens.

12. The lens device according to claim 1,
wherein the eccentric roller includes a plurality of contact portions that come into contact with a plurality of jigs that rotate the eccentric roller.

13. The lens device according to claim 12,
wherein the plurality of jigs have different tip shapes.

14. The lens device according to claim 12,
wherein the plurality of jigs include a first jig and a second jig, and
the contact portion includes
a first contact surface that is capable of being brought into contact with only the first jig among the first jig and the second jig in a direction along the rotation axis, and
a second contact surface that is capable of being brought into contact with only the second jig among the first jig and the second jig in the direction along the rotation axis.

15. The lens device according to claim 14,
wherein the second contact surface is an upper surface of a wall portion that extends from the first contact surface, and
a side surface of the wall portion is capable of being brought into contact with the first jig and the second jig in a rotation direction.

16. The lens device according to claim 15,
wherein a plurality of wall portions are disposed circumferentially around the rotation axis.

17. The lens device according to claim 14,
wherein the plurality of jigs include a third jig including two tip portions, and
the contact portion includes one or more pairs of hole portions into which the two tip portions are insertable at positions symmetric about the rotation axis.

18. An imaging apparatus comprising:
the lens device according to claim 1.
